(19) United States
(12) Patent Application Publication
(10) Pub. No.: US 2016/0126649 A1
(43) Pub. Date: May 5, 2016

(54) Connector

(71) Applicant: IRISO ELECTRONICS CO., LTD., Kanagawa (JP)

(72) Inventor: Toru Takane, Kanagawa (JP)

(73) Assignee: IRISO ELECTRONICS CO., LTD., Kanagawa (JP)

(21) Appl. No.: 14/922,263

(22) Filed: Oct. 26, 2015

(30) Foreign Application Priority Data
Oct. 30, 2014 (JP) 2014-220989

(51) Int. Cl. H01R 12/77; H01R 13/42

(52) U.S. Cl. CPC H01R 12/771; H01R 13/42

(57) ABSTRACT

A connector includes a terminal, a housing configured to hold the terminal and having an insertion port for a flat conductor and a fitting chamber where the flat conductor and the terminal are in conductive contact, and an engaging projection with which the flat conductor engages in a removing direction inside the fitting chamber. The flat conductor includes an engaging recess provided in a side edge portion along an inserting direction in the fitting chamber and having an engaging edge portion configured to abut on and engage with the engaging projection in the removing direction, and a projecting piece part located between the engaging edge portion and a distal end part of the flat conductor. The fitting chamber has an escape space. When the flat conductor is removed, the projecting piece part abuts on the engaging projection, and is displaced in the inserting direction to enter the escape space.

### BACKGROUND OF THE INVENTION

1. Field of the Invention

The present invention relates to a connector that conductively connects a flat conductor and a circuit board.

2. Description of the Related Art

Connectors conventionally used in electronic apparatuses are mounted on a circuit board to conductively connect the circuit board to, for example, a flexible printed circuit (FPC) or a flexible flat cable (FFC) (referred to as a “flat conductor” in the specification and the claims). These connectors are installed in a lot of electronic apparatuses because they can connect an apparatus inner unit, such as a computer or a liquid crystal display, to the circuit board.

As such a connector, for example, Japanese Unexamined Patent Application Publication No. 2011-222141 discloses a connector including a lock mechanism that fixes a flat conductor to the connector by engaging with engaging recesses provided in side edges of the flat conductor extending in the inserting direction of the flat conductor, that is, in the longitudinal direction of the flat conductor. To pull out the flat conductor from the connector, first, a lock part is operated to disengage from the engaging recesses of the flat conductor. Then, the flat conductor can be pulled out from the connector by being pulled in this state.

However, when pulling out the flat conductor from the connector having such a lock mechanism, the operator sometimes makes a mistake in the operation and pulls the flat conductor without releasing the lock or without sufficiently releasing the lock. In this case, in the above-described connector, projections are caught by projecting piece parts closer to the distal end than the engaging recesses. When further force is applied in this state, rupture may occur in root portions of the projecting piece parts. If the projecting piece parts are torn by the pulling force, they remain inside the connector and touch the flat conductor and terminals. This may cause connection failure.

### SUMMARY OF THE INVENTION

The present invention has been made in the context of the above-described related art, and an object of the invention is to suppress rupture of a flat conductor even when a pulling force in a removing direction is applied to the flat conductor in a lock state in a connector including a lock mechanism that fixes the flat conductor to the connector.

To achieve the above object, the present invention has the following features.

A connector according to an aspect of the present invention includes a flat conductor, a terminal in conductive contact with the flat conductor, a housing configured to hold the terminal and having an insertion port for the flat conductor and a fitting chamber where the flat conductor and the terminal are in conductive contact with each other, and a lock part with which the flat conductor engages in a removing direction inside the fitting chamber. The flat conductor includes an engaging recess provided in a side edge portion along an inserting direction into the fitting chamber and having an engaging edge portion configured to abut on and engage with the lock part in the removing direction, and a projecting piece part located between the engaging edge portion and a distal end part of the flat conductor. The fitting chamber has, at a position opposed to a distal end of the projecting piece part, an escape space configured to receive the projecting piece part that abuts on the lock part and is deformed in the inserting direction by pulling the flat conductor in the removing direction.

When the flat conductor is strongly pulled in a state in which the engaging edge portion of the projecting piece part is engaged with the lock part, a body part of the flat conductor except for the projecting piece part is pulled in the removing direction, whereas the projecting piece part is caught by the lock part and is left between the lock part and an inner wall. In this case, reactive force to force of contact and engagement of the engaging edge portion with the lock part is concentrated and applied to a root of the projecting piece part by the pull in the removing direction. In particular, in the connector of the related art, the inner wall of the fitting chamber is provided at a position abutting on the distal end part of the flat conductor in a fitted state. In this case, if the flat conductor is strongly pulled in a state in which the engaging edge portion is engaged with the lock part, since there is no space around the projecting piece part, the projecting piece part cannot move and deform to avoid engagement of the lock part. For this reason, the projecting piece part cannot come out from between the lock part and the inner wall of the fitting chamber. Hence, excessive force is sometimes applied to the root of the projecting piece part, and this causes rupture of the projecting piece. As a result, only the body part of the flat conductor except for the projecting piece part is pulled out of the fitting chamber, and the projecting piece part is left inside the fitting chamber.

In contrast, the fitting chamber according to the aspect of the present invention has, at the position opposed to the distal end of the projecting piece part, the escape space that receives the projecting piece part abutting on the lock part and deformed in the inserting direction by pulling the flat conductor in the removing direction. In this case, when the flat conductor is strongly pulled in the removing direction in the lock state, as described above, the projecting piece part can deform in the inserting direction. This is because the fitting chamber has the escape space that can receive the deformed projecting piece part. Specifically, when the engaging edge portion abuts on the lock part, the projecting piece part attempts to stay at the position closer to the back side of the fitting chamber than the lock part. When the body part of the flat conductor is further pulled in the removing direction in this state, load is applied from the lock part to the projecting piece part. As a result, the projecting piece part deforms so that the distal end thereof is directed in the inserting direction in a state in which the projecting piece part is connected at the root to the body part. Then, the deformed projecting piece part can enter the escape space. In this way, the projecting piece part can be deformed by the load from the lock part so that it turns from the root. Such deformation allows the projecting piece part to move in the removing direction along with the body part of the flat conductor while deforming to avoid engagement of the lock part. Thus, excessive load is unlikely to be applied to the root of the projecting piece part, and this suppresses rupture. Also, the flat conductor can be removed from the connector without causing rupture.

A connector according to another aspect of the present invention is conductively connected to a flat conductor serving as a connecting object, and includes a terminal in conductive contact with the flat conductor, a housing configured to hold the terminal and having an insertion port for the flat conductor and a fitting chamber where the flat conductor and the terminal are in conductive contact with each other, and a lock part with which the flat conductor engages in a removing direction inside the fitting chamber. The flat conductor includes an engaging recess provided in a side edge portion along an inserting direction into the fitting chamber and having an engaging edge portion configured to abut on and engage with the lock part in the removing direction, and a projecting piece part located between the engaging edge portion and a distal end part of the flat conductor. The housing has an escape space configured to receive the projecting piece part that abuts on the lock part and is deformed in the inserting direction when the flat conductor is removed.

According to the present invention, the connector can be provided with the operation and effect of the present invention by fitting the flat conductor in the connector.

A length of the escape space in a widthwise direction of the flat conductor in a fitted state may be more than a length of the projecting piece part in the widthwise direction. This reduces a portion of the distal end part of the flat conductor in contact with an inner wall of the fitting chamber on the side of the root of the projecting piece part. Hence, it is possible to reduce a portion of the projecting piece part that is restricted by the inner wall from deforming and to easily deform the projecting piece part. Further, since the escape space can be made wide, the deformed projecting piece part is allowed to escape more. Thus, it is possible to further suppress rupture at the root of the projecting piece part.

According to the present invention, it is possible to provide the connector that has the lock part for fixing the flat conductor to the connector and that suppresses rupture of the flat conductor even when a pulling force in the removing direction is applied to the flat conductor in a state in which the lock part is engaged with the flat conductor.

### BRIEF DESCRIPTION OF THE DRAWINGS

FIG. 1 is an external perspective view of a connector according to an embodiment.

FIG. 2 is a front view of the connector of FIG. 1.

FIG. 3 is a rear view of the connector of FIG. 1.

FIG. 4 is a plan view of the connector of FIG. 1.

FIG. 5 is a bottom view of the connector of FIG. 1.

FIG. 6 is a right side view of the connector of FIG. 1.

FIG. 7 illustrates a flat conductor to be in conductive contact with the connector of FIG. 1.

FIG. 8 is an external perspective view of a reinforcing member provided in the connector of FIG. 1.

FIG. 9 is an external perspective view of an elastic lock piece provided in the connector of FIG. 1.

FIG. 10 is an explanatory cross-sectional view of the connector of FIG. 1 in which the flat conductor is fitted.

FIGS. 11A and 11B illustrate a state in which engaging projections of elastic lock pieces are engaged with the flat conductor, FIG. 11A is a cross-sectional view taken along the plate thickness direction of the flat conductor, and FIG. 11B is a cross-sectional view taken along the plate surface direction of the flat conductor.

FIG. 12 is an enlarged partial cross-sectional view of a section of arrow A in FIG. 11B.

FIGS. 13A and 13B illustrate a state in which projecting piece parts of the flat conductor are deformed, FIG. 13A is a cross-sectional view taken along the plate thickness direction of the flat conductor, and FIG. 13B is a cross-sectional view taken along the plate surface direction of the flat conductor.

FIG. 14 is an enlarged partial cross-sectional view of a section of arrow B in FIG. 13B.

### DESCRIPTION OF THE PREFERRED EMBODIMENTS

A connector according to a preferred embodiment of the present invention will be described below with reference to the drawings. In the following embodiment, a connector 1 is mounted on a circuit board 2 to conductively connect a flat conductor 3, such as an FPC or an FFC, to a circuit of the circuit board 2.

In this specification, the widthwise direction (longer side direction) of the connector 1 is referred to as an X-direction, the front-rear direction (shorter side direction) is referred to as a Y-direction, and the height direction (up-down direction) of the connector 1 is referred to as a Z-direction. In the front-rear direction Y of the connector 1, the side where an insertion port 4a is provided is referred to as a “front side”, and the opposite side is referred to as a “rear side.” Further, the side of the circuit board 2 in the height direction Z is referred to as a “lower side”, and the side of the connector 1 is referred to as an “upper side.” However, these do not limit the mounting method and use method of the connector 1 on the circuit board 2.

Since the left side view is shown symmetrically with the right side view, a description thereof is skipped. Further, since two reinforcing members 6 provided in the connector 1 are symmetrically formed, an external perspective view of one of the reinforcing members 6 is omitted.

### Embodiment

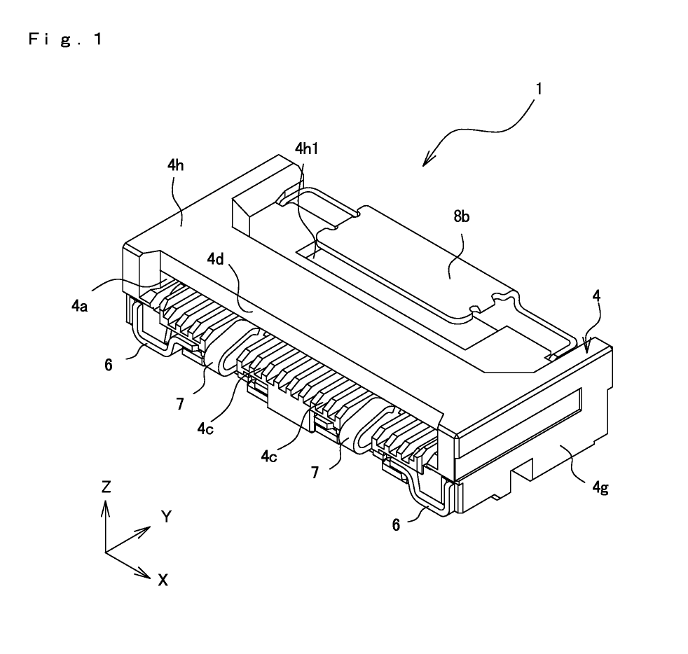

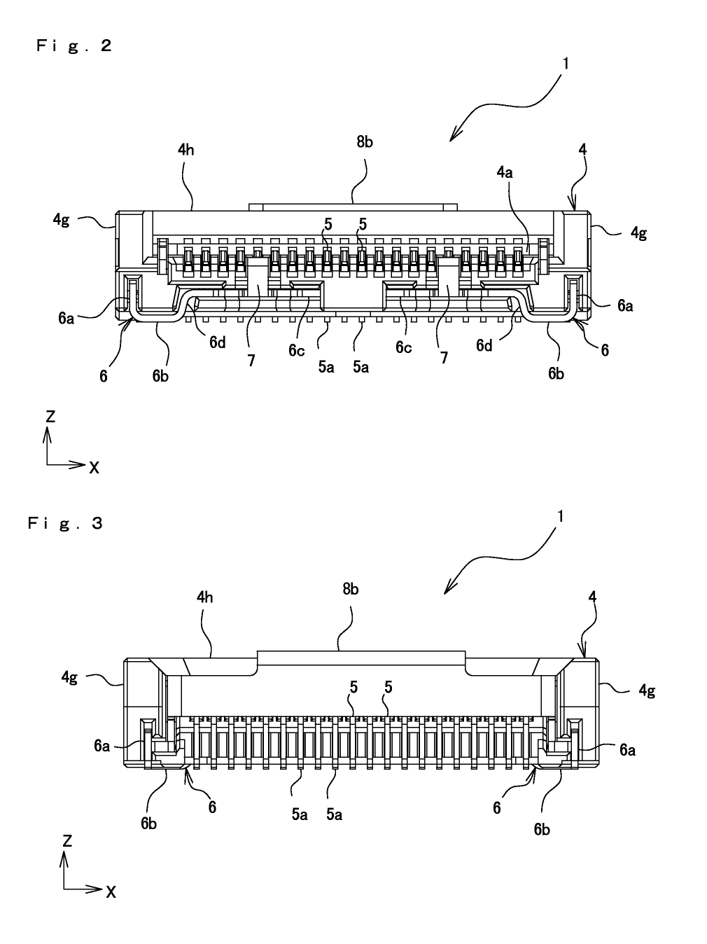

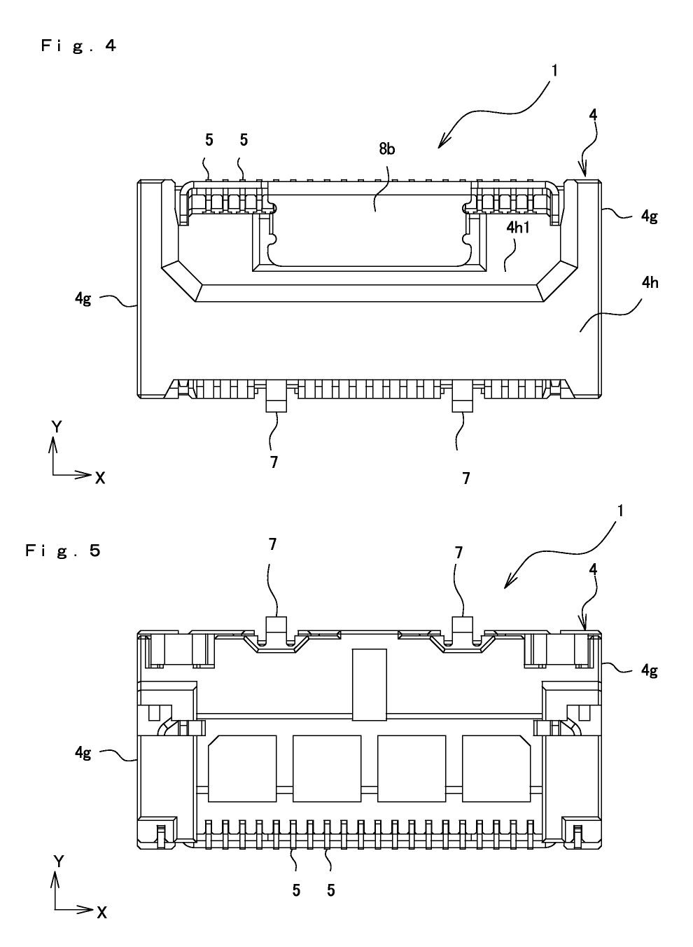

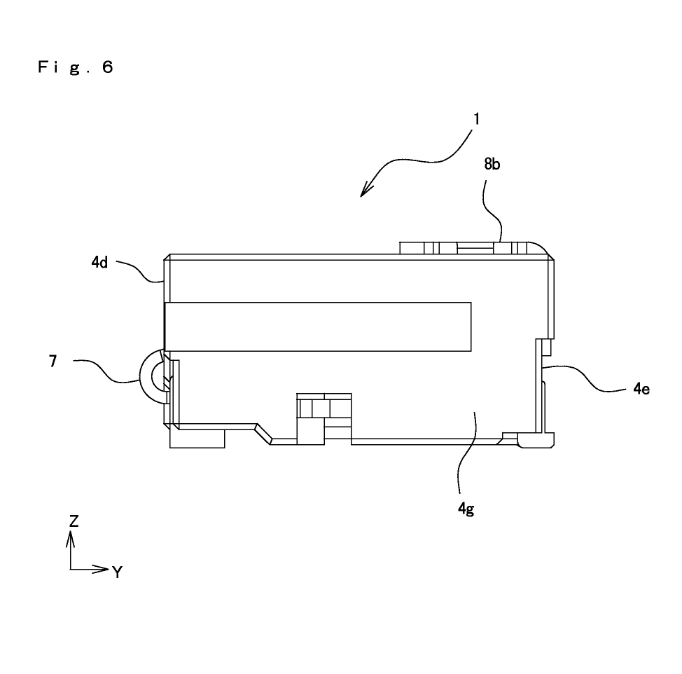

### FIGS. 1 to 14

A connector 1 according to an embodiment is laid flat and fixed to a circuit board 2. By inserting a flat conductor 3 into the connector 1 in this state, the circuit board 2 and the flat conductor 3 are connected conductively.

The connector 1 is mounted on the circuit board 2, and conductively connects the flat conductor 3 and the circuit board 2. Further, as illustrated in FIGS. 1 to 14, the connector 1 includes a housing 4, terminals 5, reinforcing members 6, ground terminals 7, and an elastic lock piece 8.

First, the structure of the flat conductor 3 serving as a connecting object to be connected by the connector 1 of the embodiment will be described.

### Flat Conductor

The flat conductor 3 includes projecting piece parts 3A and a body part 3B.

The projecting piece parts 3A are formed by insulating coating. The projecting piece parts 3A project in the widthwise direction X from a distal end of the body part 3B, and are located between engaging edge portions 3c1 and a distal end part 3C of the flat conductor 3 (to be described later). The projecting piece parts 3A are also disposed on both sides in the widthwise direction X of a conductive wire 3a exposed from insulating layers 3b (to be described later).

The body part 3B includes a conductive wire 3a, insulating layers 3b, engaging recesses 3c, and a ground connecting portion 3d.

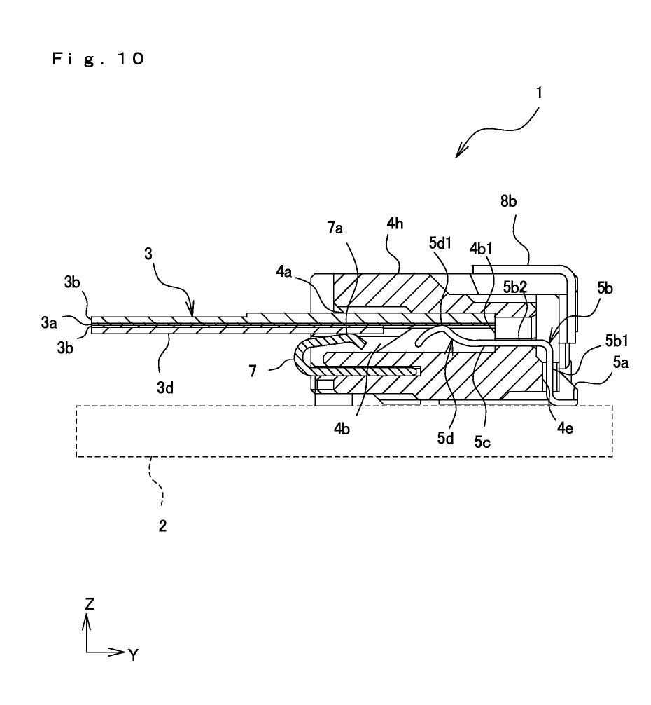

As illustrated in FIG. 10, both front and back surfaces of the conductive wire 3a are covered with the insulating layers 3b, and the conductive wire 3a is exposed outside from the insulating layers 3b at an insertion end (distal end) into the housing 4. In this exposed portion, the conductive wire 3a is in conductive contact with the terminals 5 of the connector 1.

The insulating layers 3b are formed by insulating coating, and are stacked on both front and back surfaces of the conductive wire 3a, as described above.

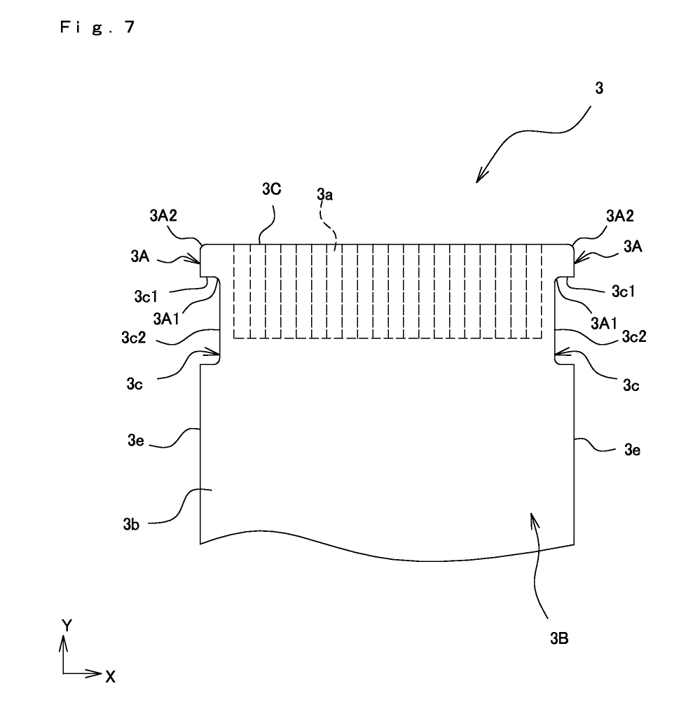

As illustrated in FIG. 7, the engaging recesses 3c are provided in corresponding side edge portions 3e that extend in the inserting direction of the flat conductor 3 on the side of the distal end part 3C. The engaging recesses 3c are formed as cutout portions by cutting out the side edges of the flat conductor 3 in the shape of a recess. The engaging recesses 3c include their respective engaging edge portions 3c1 and inner edge portions 3c2.

The engaging edge portions 3c1 are formed by plate edges extending in the widthwise direction X of the flat conductor 3, and engaging projections 8a of an elastic lock piece 8 (to be described later) are engaged with the engaging edge portions 3c1.

The inner edge portions 3c2 are formed by plate edges extending in the inserting direction of the flat conductor 3, and are provided on the inner sides of the engaging recesses 3c.

The configuration of the connector 1 of the embodiment will be described below.

### Housing

The housing 4 is formed of insulating resin, and is shaped like a substantially rectangular parallelepiped, as illustrated in FIGS. 1 to 6. The housing 4 includes an insertion port 4a for the flat conductor 3, a fitting chamber 4b, and terminal receiving portions 4c.

The insertion port 4a is provided in a front side wall 4d at the front of the housing 4, and communicates with the fitting chamber 4b.

The fitting chamber 4b is provided inside the housing 4, and is surrounded by inner walls 4b1 extending in the front-rear direction Y and a back-side inner wall (hereinafter simply referred to as a back wall) 4b2 extending in the widthwise direction X. The fitting chamber 4b further includes escape spaces 4f on its rear side.

The escape spaces 4f are provided on the rear side of the distal end part 3C of the flat conductor 3 in a fitted state. The escape spaces 4f are also provided opposed to distal ends of the projecting piece parts 3A of the flat conductor 3 in the fitted state.

The escape spaces 4f are provided between first side wall portions 4f1 extended from the inner walls 4b1 along the front-rear direction Y of the fitting chamber 4b, and second side wall portions 4f2 opposed to the first side wall portions 4f1. The length of the escape spaces 4f in the height direction Z is substantially equal to the length of the flat conductor 3 in the plate thickness direction. By thus forming no extra space between the flat conductor 3 in the fitted state and the inner walls 4b1, the height of the connector 1 can be made low as a whole.

A plurality of terminal receiving portions 4c communicate with the fitting chamber 4b, and are arranged in parallel in the widthwise direction X of the housing 4 on a lower side of the fitting chamber 4b. The terminals 5 are received one by one in the corresponding terminal receiving portions 4c.

### Terminals

The terminals 5 are formed by bending a conductive metal plate, and are arranged in parallel in the widthwise direction X of the housing 4 by being received one by one in the corresponding terminal receiving portions 4c. Further, as illustrated in FIG. 10, each terminal 5 includes a circuit-board connecting portion 5a, a fixed portion 5b, an elastic piece portion 5c, and a contact portion 5d.

The circuit-board connecting portion 5a is provided at one end of the terminal 5, and is soldered to the circuit board 2.

The fixed portion 5b has a vertical piece portion 5b1 and a horizontal piece portion 5b2.

The vertical piece portion 5b1 is provided along a rear side wall 4e of the housing 4, and is connected at a lower end to the circuit-board connecting portion 5a. The horizontal piece portion 5b2 penetrates the rear side wall 4e of the housing 4, and the terminal 5 is fixed to the housing 4 in that position. In the embodiment, the terminal 5 and the housing 4 are formed by insert integral molding.

The elastic piece portion 5c extends in the front-rear direction Y in a cantilevered manner from a distal end of the horizontal piece portion 5b2 of the fixed portion 5b toward the insertion port 4a of the housing 4. Further, the contact portion 5d is elastically supported at a distal end of the elastic piece portion 5c. The elastic piece portion 5c elastically deforms in the height direction Z of the connector 1 by using a portion connected to the horizontal piece portion 5b2 as a fulcrum inside the fitting chamber 4b.

The contact portion 5d is bent in a peak shape in a direction to contact with the flat conductor 3, and a contact part 5d1 is provided at almost the center of the contact portion 5d to be conductively connected to the flat conductor 3. The contact part 5d1 is in conductive contact with the flat conductor 3 inside the fitting chamber 4b.

### Reinforcing Members

A pair of reinforcing members 6 are formed by a conductive metal plate, and are provided on the lower side of the housing 4, on the front side in the front-rear direction Y, and at corresponding ends of the housing 4 in the widthwise direction X, as illustrated in FIG. 1. The reinforcing members 6 are symmetrical with each other, and reinforce wall bodies 4g that form the fitting chamber 4b.

Each reinforcing member 6 includes a fixing portion 6a fixed to the housing 4, a ground connecting portion 6b, a reinforcing plate 6c, and a stepped portion 6d.

The fixing portion 6a has a plate surface along the height direction Z, and is press-fitted in a press-fitting hole (not illustrated) provided on the bottom side of the housing 4. The fixing portion 6a fixes the reinforcing member 6 to the housing 4.

The ground connecting portion 6b has a plate surface parallel to a bottom surface of the housing 4. Further, the ground connecting portion 6b is exposed outside from the housing 4 on the lower side of the housing 4, and is soldered to a ground connecting pad (not illustrated) provided in the circuit board 2.

The reinforcing plate 6c has a plate surface parallel to the bottom surface of the housing 4. Further, the reinforcing member 6 is inserted in the plate of a wall body 4g that forms a bottom wall of the housing 4, but is not exposed from the housing 4 toward the bottom side.

The stepped portion 6d is provided between the ground connecting portion 6b and the reinforcing plate 6c. While the ground connecting portion 6b is located on the lower side of the connector 1 and is exposed from the bottom surface, as described above, the reinforcing plate 6c is located at a position higher than the ground connecting portion 6b, and is stored inside the housing 4. These two portions having different heights are connected by the stepped portion 6d.

### Ground Terminals

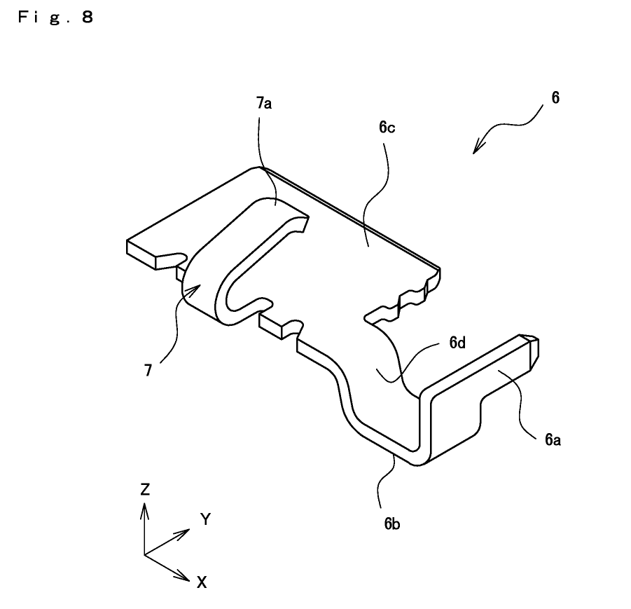

Each ground terminal 7 is formed by a conductive metal piece, and is provided integrally with the reinforcing member 6. As illustrated in FIG. 8, the ground terminal 7 is provided at each end of the housing 4 in the widthwise direction X.

The ground terminal 7 is substantially U-shaped so that it extends in a cantilevered manner from the reinforcing member 6 toward the front side in the front-rear direction Y, is bent upward, and is bent back toward the rear side in the front-rear direction Y. A distal end of the ground terminal 7 is located inside the fitting chamber 4b, and has a bent portion 7a. The bent portion 7a is bent like a peak in a direction to contact with the flat conductor 3 in a fitted state and contacts with the ground connecting portion 3d of the flat conductor 3.

By thus forming the ground terminal 7 integrally with the reinforcing member 6, the ground terminal 7 and the reinforcing member 6 can be attached to the housing 4 by one operation. Hence, it is possible to enhance assembly efficiency and to make the number of components less than when the ground terminal 7 and the reinforcing member 6 are separately provided.

### Elastic Lock Piece

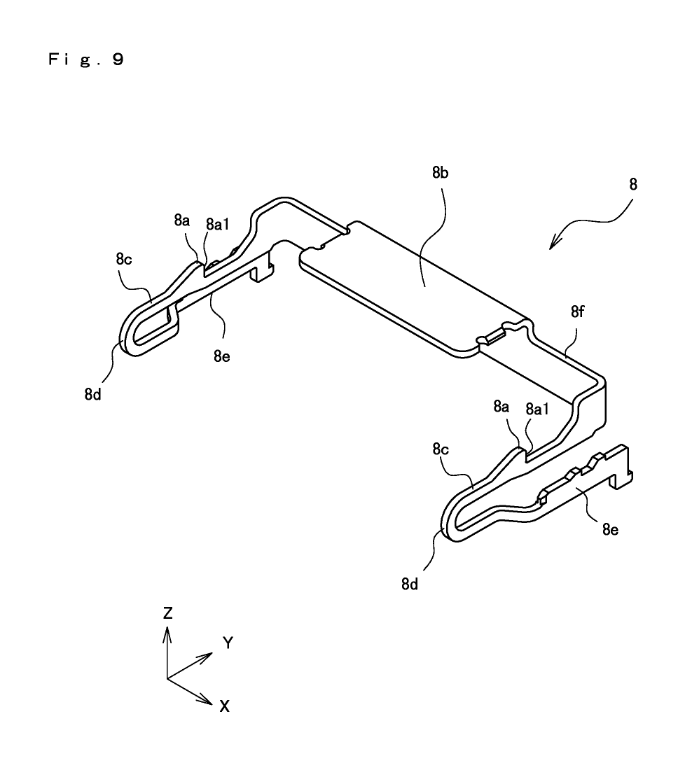

As illustrated in FIG. 9, the elastic lock piece 8 includes fixed portions 8e, curved portions 8d, elastic arms 8c, engaging projections 8a serving as a “lock part”, extended portions 8f, and an operating portion 8b.

The fixed portions 8e extend frontward in the front-rear direction Y. Projections are provided on upper sides of the fixed portions 8e, and are fixed by being press-fitted in fixing grooves (not illustrated) provided in the fitting chamber 4b of the housing 4.

The curved portions 8d continue from the fixed portions 8e, and are substantially U-shaped to protrude frontward in the front-rear direction Y. Further, the curved portions 8d are provided closer to the center side in the widthwise direction X than the fixed portions 8e. While the fixed portions 8e are fixed inside the wall bodies 4g of the housing 4, the curved portions 8d are stored inside the fitting chamber 4b.

The elastic arms 8c are formed by plate-like pieces, and extend rearward in the front-rear direction Y from the curved portions 8d.

The engaging projections 8a are provided at almost the centers of the elastic arms 8c in the front-rear direction Y to project upward in a peak shape. The engaging projections 8a have their respective abutting edges 8a1 along the height direction Z. The plate width of the engaging projections 8a corresponds to about a half of the length of the engaging edge portions 3c1 in the plate width direction of the flat conductor 3. By thus making the length of the engaging edge portions 3c1 more than the plate width of the engaging projections 8a, the engaging projections 8a can be firmly engaged with the engaging edge portions 3c1. This can enhance the fall prevention effect.

By pushing the operating portion 8b (to be described later) downward, the curved portions 8d are elastically deformed, and the elastic arms 8c are also elastically deformed in the height direction Z. At this time, the engaging projections 8a are elastically displaced in the height direction Z along with the elastic deformation of the elastic arms 8c.

The extended portions 8f are shaped like a substantially rectangular flat plate to continue from rear end portions of the elastic arms 8c and to extend in the widthwise direction X. The extended portions 8f are also exposed outside on the rear side of the housing 4, and are disposed along the rear side wall 4e.

The operating portion 8b is shaped like a substantially rectangular flat plate to continue from the extended portions 8f and to extend in the widthwise direction X. The operating portion 8b is also provided along an upper surface of a top part 4h on the upper side of the housing 4 and above a recess 4h1 provided in the top part 4h.

### Size Reduction of Connector

The elastic lock piece 8 is structured so that the elastic arms 8c, the engaging projections 8a, the curved portions 8d, and the fixed portions 8e are all stored inside the housing 4. Hence, exposure of the elastic lock piece 8 to the outside of the housing 4 is reduced, and this contributes to size reduction of the entire connector 1.

The ground connecting portion 6b of each reinforcing member 6 does not protrude outside from the housing 4 in the plate surface direction of the circuit board 2, but is provided inside the bottom surface of the housing 4. Hence, the connector 1 can be made more compact and the occupation area thereof on the circuit board 2 can be reduced.

A bottom side of the ground connecting portion 6b functions as a portion to be soldered to the circuit board 2, where the connector 1 is fixed to the circuit board 2. The fixing portion 6a is located on the bottom side of the housing 4, but does not protrude outside from the housing 4. Hence, the connector 1 can also be made more compact in this regard.

The operating portion 8b is disposed on the upper side of the recess 4h1 of the top part 4h. To remove the flat conductor 3 from the connector 1, the operating portion 8b is pushed down toward the housing 4. At this time, the operating portion 8b is displaced to enter the recess 4h1 of the housing 4. Hence, the operating portion 8b can be sufficiently pushed toward the housing 4 without interfering with the housing 4. Further, since the operating portion 8b is thus disposed on the upper side of the recess 4h1, there is no need to protrude the operating portion 8b upward from the top part 4h of the housing 4 by the amount of displacement in the height direction Z. This can reduce the height of the connector 1.

### Description of Method for Fitting Flat Conductor

Next, the method for using the connector 1 will be described.

First, as illustrated in FIG. 10, the flat conductor 3 is inserted from the insertion port 4a into the fitting chamber 4b. The distal end part 3C of the flat conductor 3 comes into contact with the engaging projections 8a of the elastic lock piece 8, pushes the engaging projections 8a down toward the circuit board 2, and then goes over the engaging projections 8a. At this time, the engaging projections 8a elastically deform to tilt. In the meantime, restoring force acts on the elastic lock piece 8 so that the engaging projections 8a return toward the top part 4h. For this reason, the flat conductor 3 is pressed toward the top part 4h by the engaging projections 8a. In this state, the flat conductor 3 is inserted along the lower surface of the top part 4h of the fitting chamber 4b into the fitting chamber 4b of the connector 1.

Although the housing 4 is pressed at this time by the flat conductor 3 that is pressed by the engaging projections 8a, since the reinforcing plates 6c are inserted in the plates of the wall bodies 4g of the housing 4, rigidity of the housing 4 is increased. Hence, even when the wall bodies 4g receive load from the flat conductor 3 inserted in the fitting chamber 4b, they are hard to deform.

By further inserting the flat conductor 3 toward the back side of the fitting chamber 4b after that while pushing down the engaging projections 8a of the elastic lock piece 8, the distal end part 3C of the flat conductor 3 comes into contact with the contact portions 5d of the terminals 5 from the upper side, pushes down the terminals 5, and goes over the contact parts 5d1. In this state, the flat conductor 3 is clamped by the contact parts 5d1 and the top part 4h, and is in conductive contact with the terminals 5.

### Fall Preventing Structure for Flat Conductor

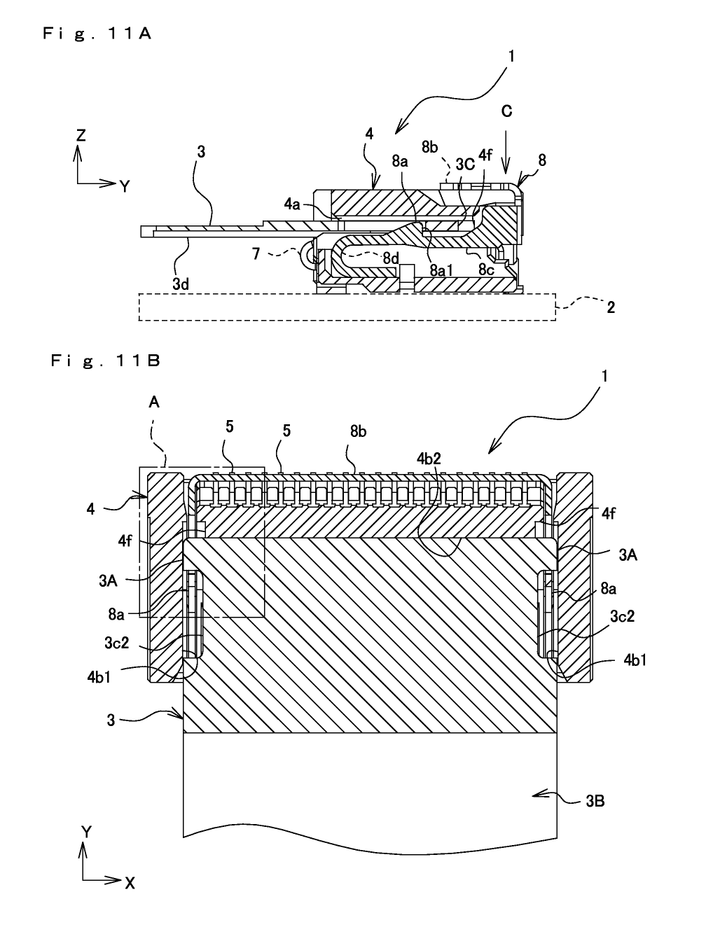

When the flat conductor 3 is inserted to the back side of the fitting chamber 4b, as described above, the engaging recesses 3c of the flat conductor 3 soon reach a position just above the engaging projections 8a of the elastic lock pieces 8. Then, the engaging projections 8a of the elastic lock piece 8 elastically displaced downward are displaced upward by the restoring force, and enter the engaging recesses 3c from below. At this time, the abutting edges 8a1 provided in the engaging projections 8a of the elastic lock piece 8 are located along the height direction Z. The abutting edges 8a1 abut on and engage with the engaging edge portions 3c1 of the engaging recess 3c, so that the connector 1 is locked (FIGS. 11A and 11B).

In this way, the elastic lock piece 8 retains the flat conductor 3 so that the flat conductor 3 does not fall off the connector 1, and this can enhance connection reliability between the connector 1 and the flat conductor 3.

When force in the removing direction is applied to the flat conductor 3 in a state in which the flat conductor 3 is locked in the connector 1, the engaging projections 8a of the elastic lock piece 8 abut on the engaging edge portions 3c1 of the engaging recess 3c in the flat conductor 3 so as to prevent the flat conductor 3 from falling off.

In this way, according to the connector 1 of the embodiment, since the flat conductor 3 can be locked in the connector 1 without providing other members such as an actuator and a slider, the size of the connector 1 can be reduced. Further, since the flat conductor 3 is not fitted along a member having a movable structure that may rattle, such as an actuator or a slider, but is fitted along the surfaces of the inner walls 4b1 of the fitting chamber 4b in the housing 4 itself, the reliable fitting state can be maintained with no unstable factor such as rattling. Further, since the lock can be achieved only one operation of inserting the flat conductor 3 into the connector 1, the fitting operation is easy.

### Method for Removing Flat Conductor

The elastic lock piece 8 has the operating portion 8b provided on the upper side of the housing 4, and can be operated from the outside of the housing 4. This operation makes it easy to remove the flat conductor 3 from the housing 4 after separating the engaging projections 8a from the engaging recesses 3c of the flat conductor 3 to release the lock state.

This removing method will be specifically described below. When the operating portion 8b is pushed downward (in a direction of arrow C), the curved portions 8d of the elastic lock piece 8 elastically deform and the elastic arms 8c tilt obliquely. Thus, the engaging projections 8a are pushed down and come out of the engaging recesses 3c of the flat conductor 3. When the engaging edge portions 3c1 of the engaging recesses 3c thus separate from the abutting edges 8a1 of the engaging projections 8a, the flat conductor 3 is disengaged and the lock state is released. Hence, the flat conductor 3 can be removed from the connector 1.

When the operating portion 8b is pushed to enter the recess 4h1 of the housing 4, the engaging projections 8a can be sufficiently displaced downward and can be removed from the engaging recesses 3c of the flat conductor 3.

As described above, the flat conductor 3 can be prevented from falling off the connector 1 by inserting the engaging projections 8a in the engaging recesses 3c of the flat conductor 3 so that the engaging edge portions 3c1 abut on and engage with the abutting edges 8a1 in the removing direction of the flat conductor 3. Further, the elastic arms 8c are elastically displaced up and down in the height direction Z by operating the operating portion 8b so that the engaging projections 8a are inserted into and removed from the engaging recesses 3c. Hence, the abutting edges 8a1 can be easily engaged with and disengaged from the engaging edge portions 3c1 of the flat conductor 3.

### Structure for Preventing Rupture of Flat Conductor

To remove the flat conductor 3 from the connector 1, it is necessary to remove the engaging projections 8a from the engaging recesses 3c of the flat conductor 3 by pushing the operating portion 8b downward and separating the abutting edges 8a1 of the engaging projections 8a from the engaging edge portions 3c1 of the engaging recesses 3c, as described above. However, the operator (not illustrated) sometimes makes a mistake in the operation procedure and pulls the flat conductor 3 without pushing down the operating portion 8b or without sufficiently pushing down the operating portion 8b.

It is assumed that the above-described escape spaces 4f are not provided and the back wall 4b2 provided in the widthwise direction X on the back side of the fitting chamber 4b abuts on both ends in the widthwise direction X of the distal end part 3C of the flat conductor 3 in the fitted state. The flat conductor 3 is further pulled in the removing direction from the state locked by the engaging projections 8a. Then, the body part 3B of the flat conductor 3 moves in the removing direction. However, since the engaging edge portions 3c1 are caught by the engaging projections 8a, the projection piece parts 3A do not follow the body part 3B of the flat conductor 3, but are left between the engaging projections 8a and the back wall 4b2.

When the flat conductor 3 is further pulled in the removing direction from this state, reactive force to the force of contact and engagement of the engaging edge portions 3c1 with the engaging projections 8a is concentrated and applied to roots 3A1 of the projecting piece parts 3A by the pull in the removing direction. Since the back wall 4b2 of the fitting chamber 4b abuts on the distal end part 3C of the flat conductor 3 in the fitted state and there is no space between the projecting piece parts 3A and the back wall 4b2, as described above, the projecting piece parts 3A cannot move and deform to avoid engagement of the engaging projections 8a. Since the projecting piece parts 3A cannot come out from between the engaging projections 8a and the back wall 4b2 of the fitting chamber 4b, excessive force is applied to the roots 3A1 of the projecting piece parts 3A, and this sometimes causes rupture. As a result, only the body part 3B of the flat conductor 3 except for the projecting piece parts 3A is pulled out of the fitting chamber 4b, and the projecting piece parts 3A are left inside the fitting chamber 4b. In this case, the conductive contact between the flat conductor 3 and the terminals 5 is hindered by fragments of the flat conductor 3, and this may reduce connection reliability. Hence, it is necessary to prevent such rupture.

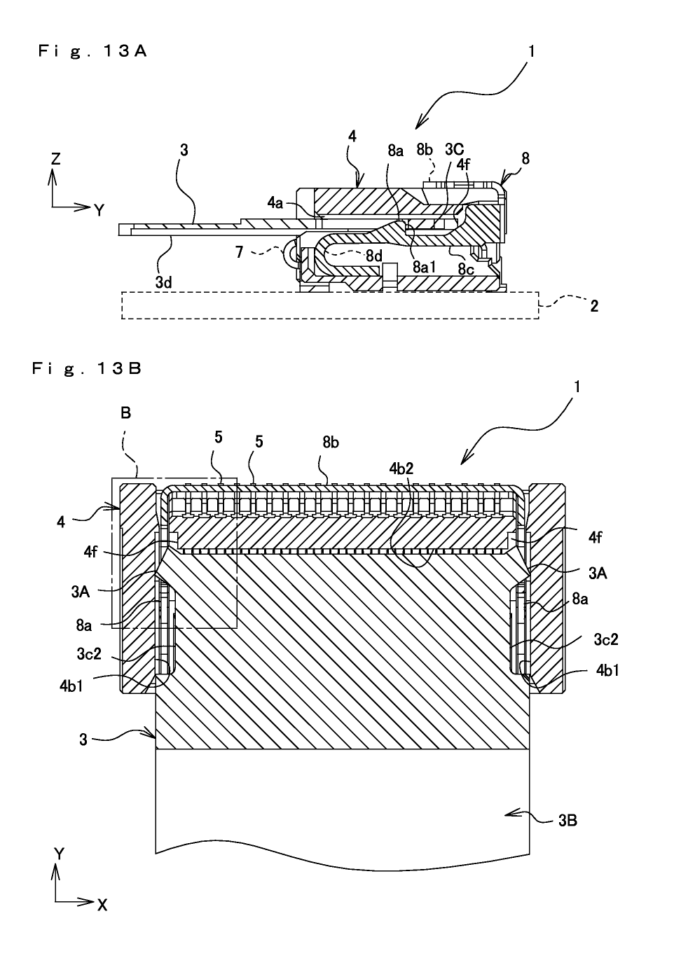

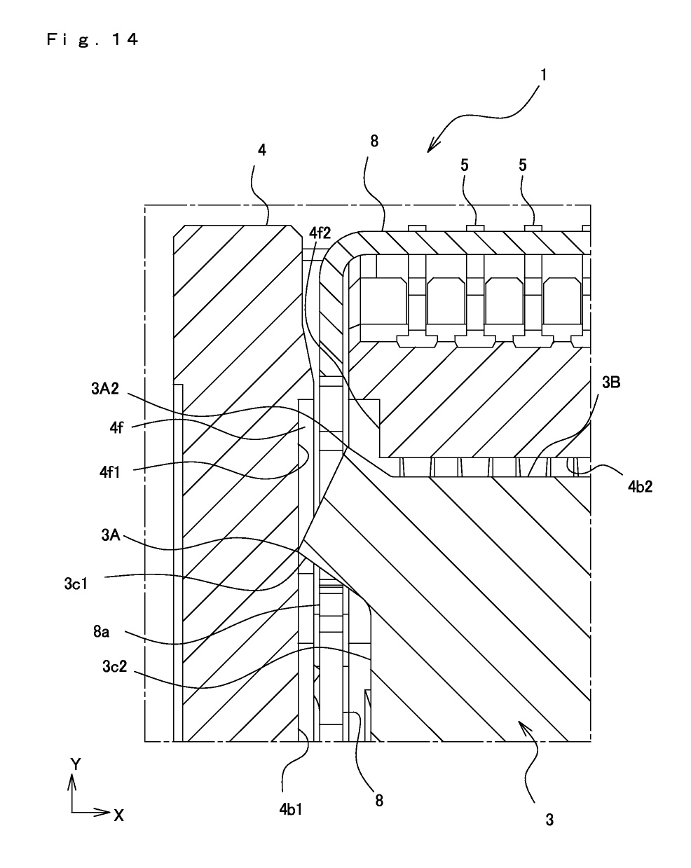

In contrast, in this embodiment, the fitting chamber 4b has, at the positions opposed to the distal ends of the projecting piece parts 3A, the escape spaces 4f (FIGS. 13 and 14) to receive the projecting piece parts 3A that abut on the engaging projections 8a and are deformed in the inserting direction by pulling the flat conductor 3 in the removing direction. In this case, when the flat conductor 3 is strongly pulled in the removing direction in the lock state, as described above, the projecting piece parts 3A can deform in the inserting direction. This is because the fitting chamber 4b has the escape spaces 4f that can receive the deformed projecting piece parts 3A. Specifically, when the engaging edge portions 3c1 abut on the engaging projections 8a, the projecting piece parts 3A attempt to stay at the positions closer to the back side than the engaging projections 8a in the fitting chamber 4b. When the body part 3B of the flat conductor 3 is further pulled in the removing direction in that state, load is applied from the engaging projections 8a to the projecting piece parts 3A. As a result, the projecting piece parts 3A deform in a state connected at the roots 3A1 to the body part 3B so that the distal ends thereof are directed in the inserting direction.

Further, in the embodiment, the projecting piece parts 3A are provided at the opposite ends of the conductive wire 3a in the widthwise direction X of the flat conductor 3. Since the insulating layers 3b formed by insulating coating are softer than the conductive wire 3a formed of a conductive metal, the projecting piece parts 3A are easy to deform. When the projecting piece parts 3A deform, the engaging edge portions 3c1 tilt with respect to the removing direction, and corner parts 3A2 of the flat conductor 3 protrude frontward from the distal end part 3C of the flat conductor 3 in the fitted state. In this way, the corner parts 3A2 can enter the escape spaces 4f.

The projecting piece parts 3A can be deformed by the load from the engaging projections 8a to turn from the roots 3A1 (FIGS. 13A, 13B, and 14). Such deformation allows the projecting piece parts 3A to deform to avoid engagement of the engaging projections 8a and move in the removing direction while following the body part 3B of the flat conductor 3. From the above, excessive load is unlikely to be applied to the roots 3A1 of the projecting piece parts 3A, and the flat conductor 3 can be removed from the connector 1 without causing rupture.

In this way, even if the flat conductor 3 is inadvertently removed from the connector 1 without releasing the lock of the elastic lock piece 8 or without sufficiently releasing the lock, rupture of the projecting piece parts 3A can be suppressed.

The first side wall portions 4f1 are formed by extending the inner walls 4b1 of the fitting chamber 4b provided in the front-rear direction Y. In contrast, the second side wall portions 4f2 are provided closer to the center in the widthwise direction X than the engaging projections 8a of the elastic lock piece 8, and are provided even closer to the center in the widthwise direction X than the inner edge portions 3c2 of the engaging recesses 3c of the flat conductor 3 in the fitted state.

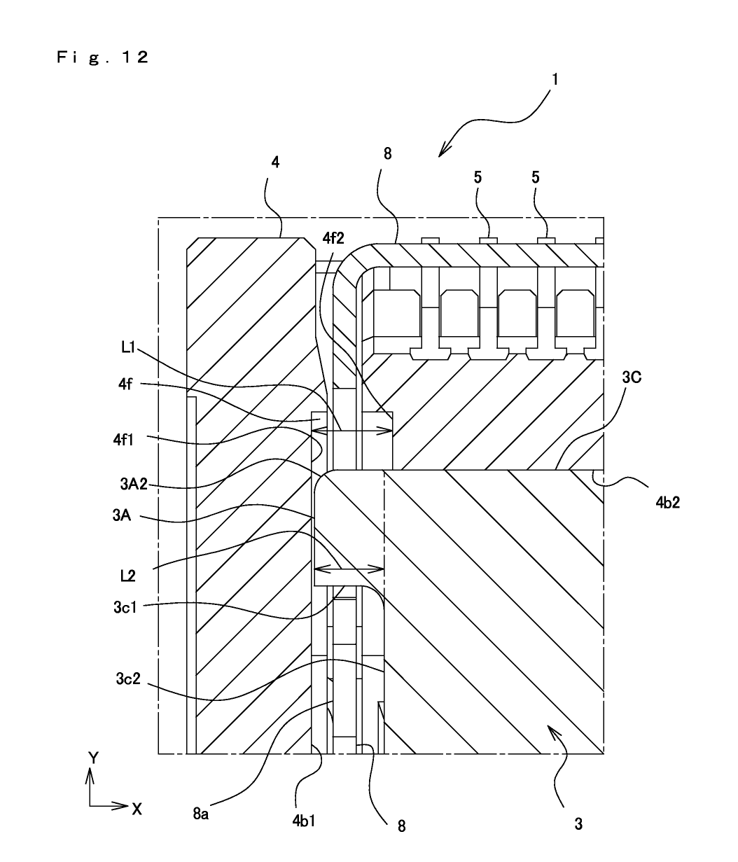

Thus, the distance between the first side wall portions 4f1 and the second side wall portions 4f2, that is, a length L1 in the widthwise direction X of the escape spaces 4f is more than a length (protrusion amount) L2 in the widthwise direction of the projecting piece parts 3A (FIG. 12). Hence, portions of the distal end part 3C of the flat conductor 3 on the side of the projecting piece parts 3A and in contact with the back wall 4b2 are reduced. Therefore, portions of the projecting piece parts 3A restricted by the back wall 4b2 from deforming are reduced, and the projecting piece parts 3A can more easily deform. Further, since the escape spaces 4f can be made wider, the deformed projecting piece parts 3A escape (are received) more. This can further suppress rupture of the roots 3A1 of the projecting piece parts 3A.

As described above, according to the connector 1 of the embodiment, even if the flat conductor 3 is removed from the connector 1 without releasing the lock of the elastic lock piece 8, rupture of the projecting piece parts 3A of the flat conductor 3 can be suppressed.

### Modifications

In the above-described embodiment, the height is reduced by making the length of the escape spaces 4f in the height direction Z substantially equal to the length of the flat conductor 3 in the plate thickness direction. Alternatively, spaces may be formed on the upper and lower sides of the flat conductor 3 by making the length of the escape spaces 4f in the height direction Z more than the length of the flat conductor 3 in the plate thickness direction. In this case, the projecting piece parts 3A are bent upward and downward by utilizing the upper and lower spaces. This allows the projecting piece parts 3A to easily avoid the engaging projections 8a. Further, even if the deformed projecting piece parts 3A crease and become uneven in the height direction Z, the unevenness can be allowed by the spaces.

In the above-described embodiment, the engaging projections 8a can be firmly engaged with the engaging edge portions 3c1 to enhance the fall prevention effect by making the plate width of the engaging projections 8a less than the length of the engaging edge portions 3c1 of the flat conductor 3 in the plate width direction of the flat conductor 3. In contrast, for example, when the length of the engaging edge portions 3c1 is made substantially equal to the plate thickness of the engaging projections 8a, the engaging projections 8a are easily separated and removed from the engaging edge portions 3c1 when the flat conductor 3 is pulled in the lock state. This can suppress rupture of the projecting piece parts 3A.

In the above-described embodiment, the length L1 of the escape spaces 4f in the widthwise direction X is more than the length (protrusion amount) L2 of the projecting piece parts 3A in the widthwise direction. Alternatively, the length L1 and the length L2 may be equal, or conversely, the length L1 may be less than the length L2. This makes adjustment so that the projecting piece parts 3A are harder to deform. The flat conductor 3 can also become harder to be removed from the connector 1 when pulled by weak force.

What is claimed is:

1. A connector comprising:
a flat conductor;
a terminal in conductive contact with the flat conductor;
a housing having an insertion port for the flat conductor and a fitting chamber where the flat conductor and the terminal are in conductive contact with each other; and
a lock part with which the flat conductor engages in a removing direction inside the fitting chamber,
wherein the flat conductor includes
an engaging recess provided in a side edge portion along an inserting direction into the fitting chamber and having an engaging edge portion configured to abut on and engage with the lock part in the removing direction, and
a projecting piece part located between the engaging edge portion and a distal end part of the flat conductor,
wherein the lock part is displaced in a thickness direction of the flat conductor to enter the engaging recess, and
wherein the fitting chamber includes an inner wall provided along the inserting direction to guide the side edge portion of the flat conductor along an insertion length, a back wall configured to abut on the distal end part of the flat conductor, and an escape space provided at a position opposed to a distal end of the projecting piece part on a side of the back wall and configured to receive the projecting piece part that abuts on the lock part and is deformed in the inserting direction by pulling the flat conductor in the removing direction.

2. The connector according to claim 1, wherein a length of the escape space in a widthwise direction of the flat conductor in a fitted state is more than or equal to a length of the projecting piece part in the widthwise direction.

3. A connector that is conductively connected to a flat conductor serving as a connecting object, the connector comprising:
a terminal in conductive contact with the flat conductor;
a housing having an insertion port for the flat conductor and a fitting chamber where the flat conductor and the terminal are in conductive contact with each other; and
a lock part with which the flat conductor engages in a removing direction inside the fitting chamber,
wherein the flat conductor includes
an engaging recess provided in a side edge portion along an inserting direction into the fitting chamber and having an engaging edge portion configured to abut on and engage with the lock part in the removing direction, and
a projecting piece part located between the engaging edge portion and a distal end part of the flat conductor,
wherein the lock part is displaced in a thickness direction of the flat conductor to enter the engaging recess, and
wherein the fitting chamber includes an inner wall provided along the inserting direction to guide the side edge portion of the flat conductor along an insertion length, a back wall configured to abut on the distal end part of the flat conductor, and an escape space provided at a position opposed to a distal end of the projecting piece part on a side of the back wall and configured to receive the projecting piece part that abuts on the lock part and is deformed in the inserting direction by pulling the flat conductor in the removing direction.

4. The connector according to claim 3, wherein a length of the escape space in a widthwise direction of the flat conductor in a fitted state is more than or equal to a length of the projecting piece part in the widthwise direction.
